(19) United States
(12) Patent Application Publication
(10) Pub. No.: US 2014/0190317 A1
(43) Pub. Date: Jul. 10, 2014

(54) Universal Propeller Wrench Multi-tool

(71) Applicant: Larry D. Rosby, Moreno Valley, CA (US)

(72) Inventor: Larry D. Rosby, Moreno Valley, CA (US)

(21) Appl. No.: 14/150,298

(22) Filed: Jan. 8, 2014

Related U.S. Application Data
(60) Provisional application No. 61/848,640, filed on Jan. 8, 2013.

(51) Int. Cl. B25B 13/48

(52) U.S. Cl. CPC B25B 13/48
USPC 81/121.1

(57) ABSTRACT

A propeller wrench for easily removing and installing boat motor propellers is described. The wrench is equipped with specially sized extensions and socket in order to expedite the job at hand. Up to seven tools are incorporated into the propeller wrench, including tools designed for both Mercury Inboard/Outboard propellers and the Volvo Penta propeller setups, making it easy to use only a single tool to accomplish the entire removal or installation of a boat propeller. The propeller wrench is designed to be universal in nature, and expedite the process of propeller installation and replacement.

### CONTINUITY

This is a non-provisional application of provisional application No. 61,848,640, filed on Jan. 8, 2013, and priority is claimed thereto.

### FIELD OF THE PRESENT INVENTION

The present invention relates generally to the removal and replacement of boat propeller nuts.

### BACKGROUND OF THE PRESENT INVENTION

Marine mechanics and private boat owners use several propeller wrenches to remove and replace propeller nuts. Unfortunately, the use of multiple tools makes the process cumbersome and time consuming. If a tool were developed that encompassed most or all of the tools required to remove and install boat propellers, the procedure could be simplified and expedited. Therefore, a need has been established for a new line of propeller wrenches.

### SUMMARY OF THE PRESENT INVENTION

The present invention presents propeller wrenches that were designed to combine multiple tools into one tool reduce the size of the tool and simplify removal and reinstallation of boat propellers. The present invention comprises several universal propeller wrenches for the marine industry to remove and replace propeller nuts. While most propeller wrenches on the market are sold individually, the present invention is designed to remove and replace propellers nuts using a single tool to get the job done of seven different tools. The present invention is comprised of one (1) unique 7-in-1 tool; five (5) 2-in-1 tools; two (2) 3-in-1 tools; and one (1) 4-in-1 designs which will make the removal and replacement of propeller nuts quick and easy. The universal propeller wrenches offer several benefits over the existing propeller wrenches that are available on the market. Among those benefits are:
Compact size—They are much smaller than the existing designs available on the market.
Attractive and Durable Construction—The tools are steel constructed and finished in a durable chrome-plated coating, ensuring that they look great and last a lifetime.
Designed to torque all propeller nuts to required specification.
Lifetime warranty on all wrenches.
Efficiency—A single tool does the same job that normally requires up to seven separate tools.
Universal—All wrenches work with several different drives.
   The present invention comprises nine (9) different models as alternate embodiments:
Universal Mercury Bravo III (DIY) Do-It-Yourself Duo-Prop Wrench.
Universal Mercury I.O. (Inboard-Outboard) 4-in-1 Duo-Prop Wrench.
Universal Volvo Penta All-in-One Duo-Prop Wrench.
Universal Volvo Penta (DIY) Do-It-Yourself Duo-Prop Wrench to fit (DPH) drive.
Universal Volvo Penta (DIY) Do-It-Yourself Duo-Prop Wrench with ½″ socket.
Universal Volvo Penta (DIY) Do-It-Yourself Duo-Prop Wrench with ¾″ socket.
Universal Volvo Penta (DIY) Do-It-Yourself Duo-Prop Wrench with 1 3/16″ and ¾″ socket.
Universal Volvo Penta (DIY) Do-It-Yourself Duo-Prop Wrench with 1 3/16″ socket.
Universal Volvo Penta (DIY) Do-It-Yourself Duo-Prop wrench to fit (XDP) drive only.

Compact size means space-saving propeller wrenches that are much smaller than the existing designs on the market, attractive and durable construction means all tools are steel constructed and finished in a durable chrome-plated coating, ensuring our propeller wrenches looks great and lasts a lifetime. Efficiency of our universal propeller tools are All-In-One tools, meaning a single tool does the same job that normally requires up to seven separate tools. Since our tools cost less, it saves our customers money, requires less space and allows you to get the job done faster. Each of the wrenches works with each several different drives. All of our propellers wrenches allow you to torque all propeller nuts to necessary specifications, unlike the tools already on the market.

### BRIEF DESCRIPTION OF THE DRAWINGS

FIG. 1 is a side view of the universal all in one Duo-Prop wrench of the present invention.

FIG. 1.1 is a rear view of the universal all in one Duo-Prop wrench of the present invention.

FIG. 1.2 is a right side view of the universal all in one Duo-Prop wrench of the present invention.

FIG. 2 is a front view of the universal two in one Duo-Prop wrench of the present invention.

FIG. 3 is the side view of the universal three in one Duo-Prop wrench of the present invention.

FIG. 3.1 is the rear view of the universal three in one Duo-Prop wrench of the present invention.

FIG. 3.2 is the right side view of the universal three in one Duo-Prop wrench of the present Invention.

FIG. 4 is the side view of the universal two in one Duo-Prop wrench of the present invention.

FIG. 4.1 is the rear view of the universal two in one Duo-Prop wrench of the present invention.

FIG. 4.2 is the right side view of the universal two in one Duo-Prop wrench of the present Invention.

FIG. 5 is the side view of the universal three in one Duo-Prop wrench of the present invention.

FIG. 5.1 is the rear view of the universal three in one Duo-Prop wrench of the present invention.

FIG. 5.2 is the top and right side view of the universal three in one Duo-Prop wrench of the present invention.

FIG. 6 is the front view of the universal two in one Duo-Prop wrench of the present invention.

FIG. 7 is the rear view of the mercury I.O four in one Duo-Prop wrench of the present invention.

FIG. 7.1 is the front view of the mercury I.O four in one Duo-Prop wrench of the present invention.

FIG. 7.2 is the right side view of the mercury I.O four in one Duo-Prop wrench of the present invention.

FIG. 8 is the front view of the mercury bravo three two in one Duo-Prop wrench of the present invention.

FIG. 9 is a front view of the Volvo penta DIY Duo-Prop wrench of the present invention.

### DETAILED DESCRIPTION OF THE PRESENT INVENTION

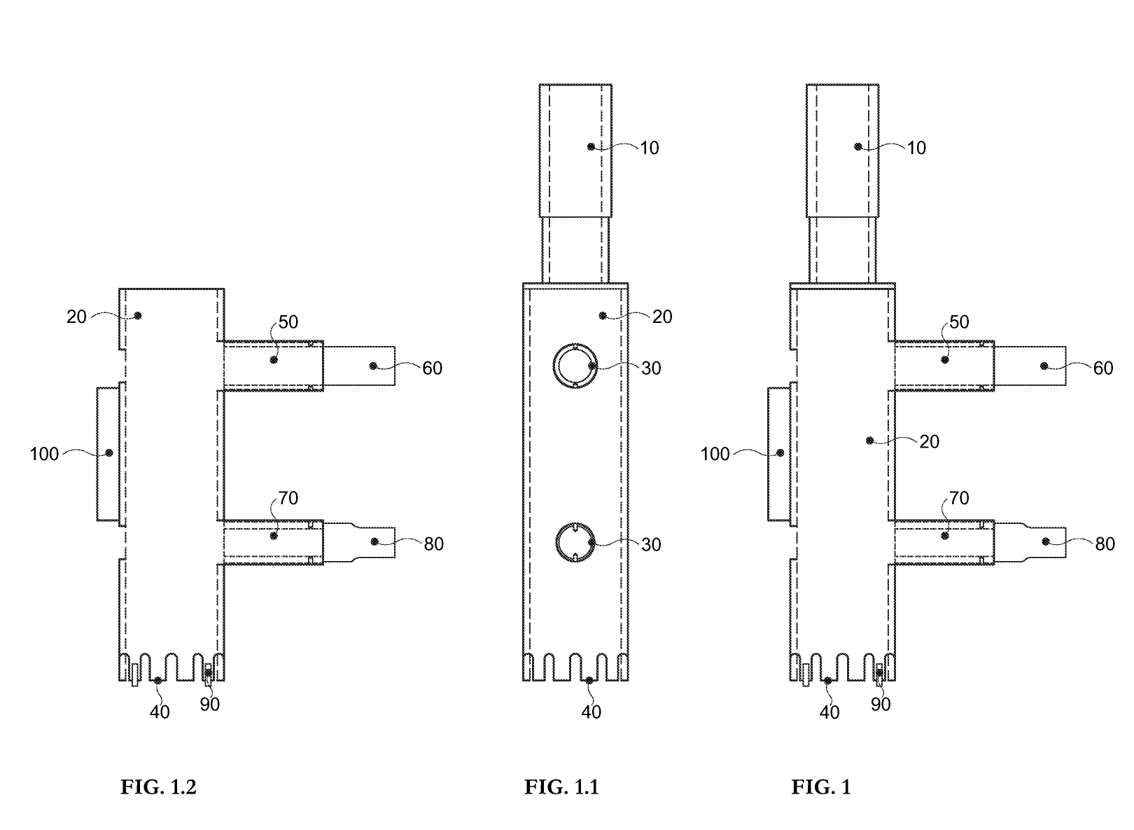

FIG. 1: a side view of the present invention, the Universal Duo-Prop Wrench, is comprised of nine (9) pieces (10, 50, 60, 20, 100, 70, 80, 40 and 90). In the preferred embodiment of the present invention, the (10, 60 and 80) are three (3) sockets and four (4) pieces (40 consists of two 2 pieces, 90 and 100). It is desirable that the first socket (10) is a 1 3/16″×4½″ long socket welded to (20), a 2″×8″ long steel tube. The second socket (60) is considered a ¾″ socket attached to (50) with a ⅛″ roll pin that will allows socket to turn clockwise and counter-clockwise. A sleeve (50) is welded to a 2″×8″ long steel tube (20). The third socket (80) is considered a ½″, 6 pt. deep socket attached to (70), a 2¼″ long steel sleeve welded to the 2″×8″ long steel tube (20). The fourth piece (90) is considered a ½″×¼″ 9-slot piece that removes one specific propeller nut. The fifth and sixth pieces (40) are considered a ½″×¼″ 9-slot tool that removes two different propeller nuts. The seventh piece (100) is considered a cone removal piece that is a 3″×⅜″×½″ long bar welded to the left side of the 2″×8″ long steel tube (20).

FIG. 1.1: a rear view of the present invention (30) considered a ¾″ hole drilled in (20) a 2″×8″ long steel tube to receive a ½″×10″ extension.

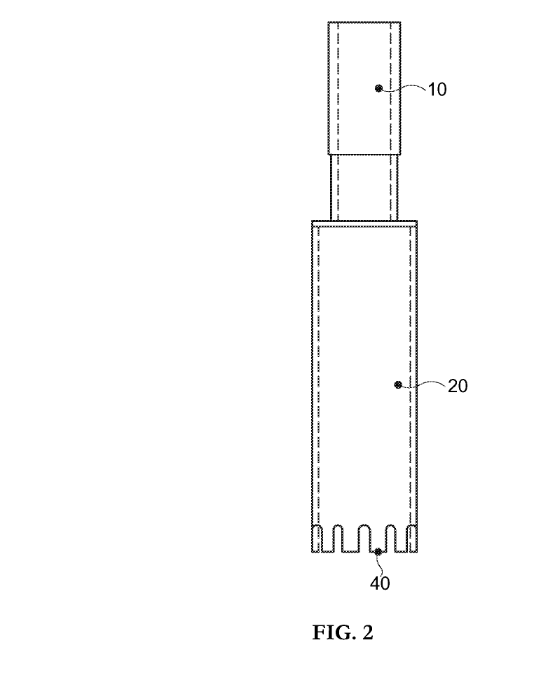

FIG. 2: a front view of the present invention, the Universal Volvo Penta 2-in-1 Duo-Prop Wrench, comprises of a first, second and third piece (10, 20, and 40), respectively. In the preferred embodiment of the present invention is a 4½″ long×1 3/16″ socket welded to (20) a 2″×8″ long steel tube. (40) is a ½″×¼″ 9-slot piece to remove and replace two different propeller nuts.

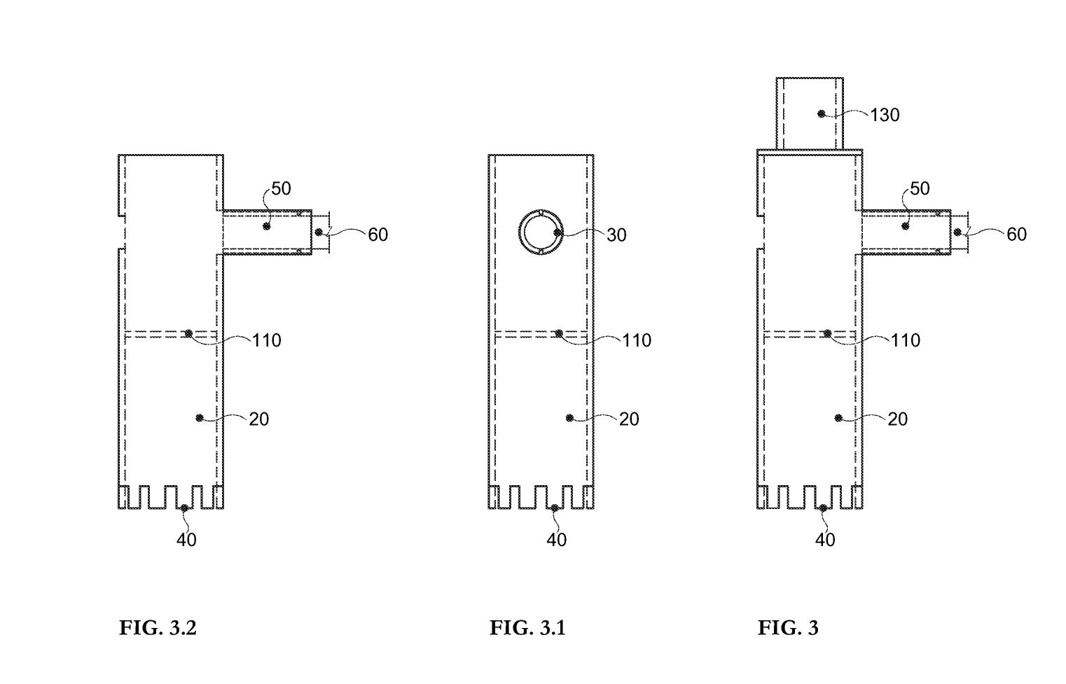

FIG. 3: a front view of the present invention, the Universal Volvo Penta 3-in-1 Duo-Prop Wrench, comprises of a first, second, third, fourth, fifth and sixth piece (130, 50, 60, 110, 20, and 40), respectively. In the preferred embodiment of the present invention (130) is a 1 3/16″ standard socket welded to a 2″×8″ long steel tube (20). A steel sleeve (50) is welded to the 2″×8″ long steel tube (20) and accommodate a ¾″ deep socket (60). (110) is a 2″ washer welded inside tube (20), a 2″×8″ long steel tube. The sixth piece (40) is a ½″×¼″ 9-slot piece to remove and replace two different propeller nuts.

FIG. 3.1: is considered to be the back side of the present invention. A ¾″ hole (30) is shown and is configured to receive a ½″ drive extension.

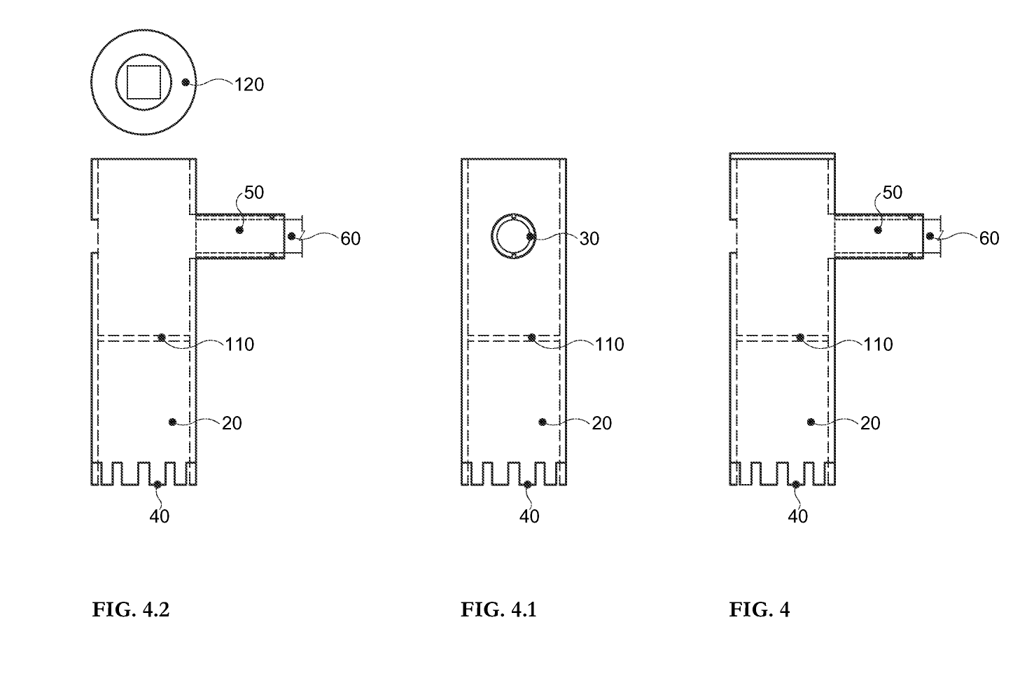

FIG. 4: a side view of the present invention comprises of 50, 60, 110, 20 and 40. (50) is a steel sleeve welded to (20) to accommodate (60) a ½″ deep socket. (110) is a steel washer welded inside (20), a 2″×8″ long steel tube with nine (9) ½″×¼″ slots on the bottom. (40) is nine (9) ½″×¼″ slots to remove and replace propeller nuts.

FIG. 4.1 is considered to be the back side of the present invention (30, 110, 20 and 40). (30) is a ¾″ hole to receive a ½″ drive extension.

FIG. 4.2 details a ½″×½″ square piece (120) which is configured to receive ½″ drive extension.

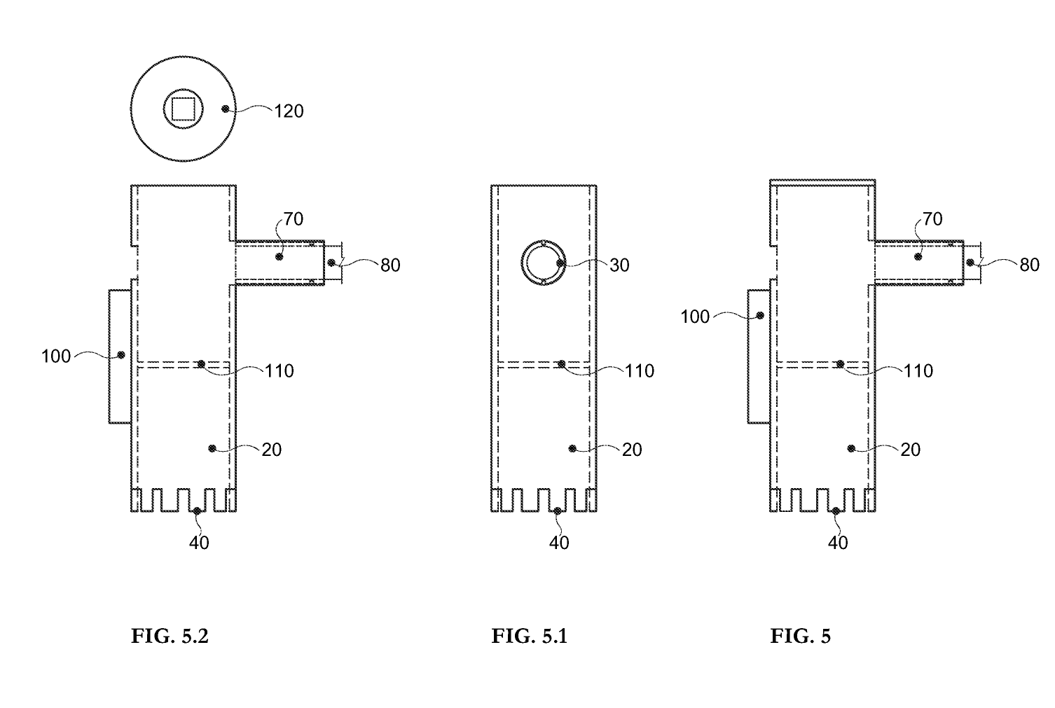

FIG. 5: a side view of the present invention comprises of the first, second, third, fourth, fifth and sixth pieces (70, 80, 110, 20, 40 and 100), respectively. In the preferred embodiment of the present invention (70) is a steel sleeve welded to a 2″×8″ long steel tube (20) to accommodate (80) a ¾″ deep socket. (110) is a steel washer welded inside two 2″×8″ long steel tubes. ½″×¼″ slots (40) can be seen in FIG. 5, of which there are preferably nine. (100) is a ½″×⅜″ bar welded to the left side of the tube to remove and replace propeller cone.

In FIG. 5.1, a back view of the present invention comprises of the first, second, third and fourth pieces (30, 110, 20 and 40). The first tool (30) is a ¾″ hole to receive 1/2″ drive extension to turn (80). The second piece (110) is a 2″ steel washer welded inside a 2⅜″×8″ long tube (20). The fourth piece (40) is a ½″×¼″ 9-slot piece designed to remove and replace one specific propeller nut.

In FIG. 5.2, a ½″×½″ square piece (120) is shown, which is designed to receive a ½″ drive extension to turn the 2⅜″×8″ long tube (20) of the present invention.

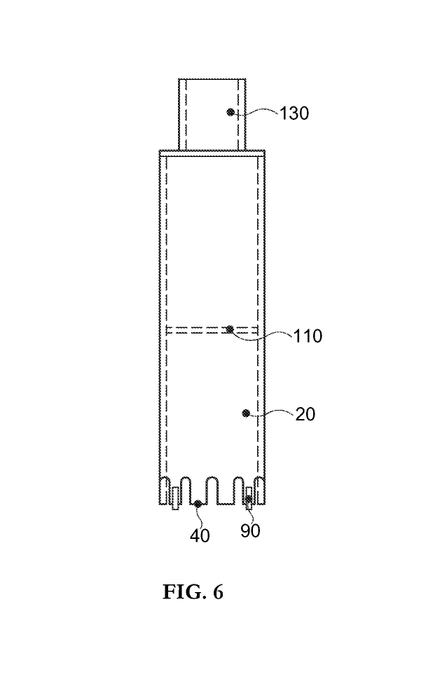

FIG. 6: a front view of the invention comprises of the first, second, third and fourth pieces (130, 110, 20, 90 and 40), respectively, in the preferred embodiment of the present invention. It is desirable that the first piece (130) is a 1 3/16″ socket welded to a 2″×8″ long carbon steel tube (20). A 2″ washer (110) is welded inside of a the 2″×8″ long carbon steel tube (20). Three (3) pins (90) are welded to a ½″×¼″ 9-slot piece (40) to remove and replace one specific propeller nut.

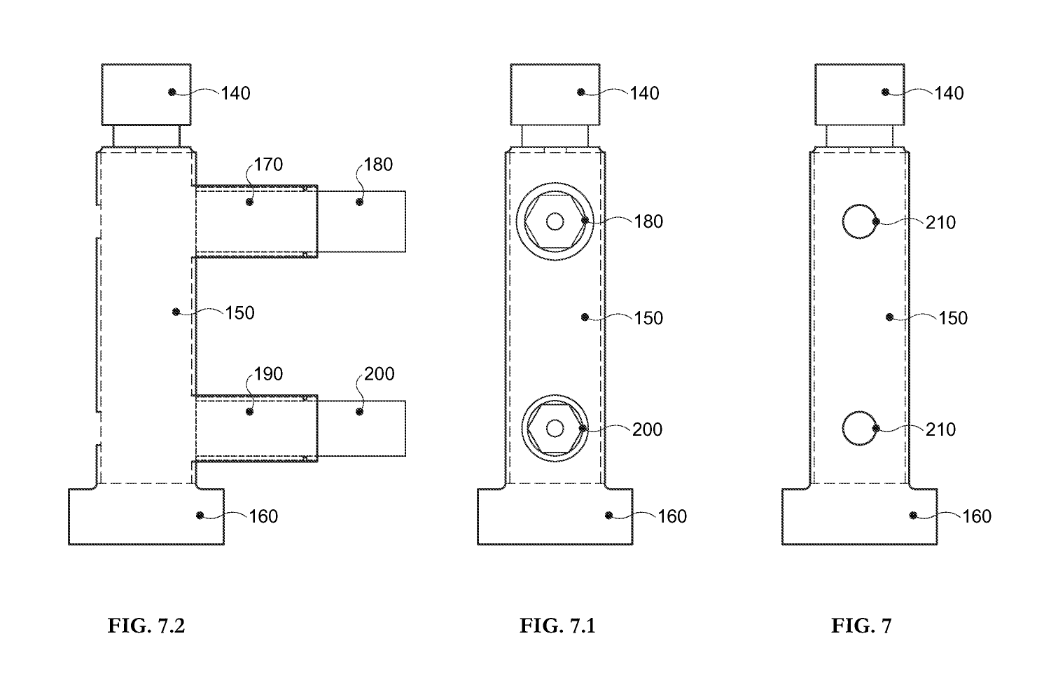

FIG. 7: a rear view of the present invention comprises of first, second, third and fourth pieces (140, 210, 150 and 160). The first piece (140) is a 1 7/16″ socket welded to (150) a 2⅜″×8″ steel tube. (210) is a ¾″ hole to receive a ½″ drive extension. (150) is a 2⅜″×8″ long steel tube and (160) is a 2¾″ hex nut to remove and replace propeller nuts.

FIG. 7.1: a front view of the present invention (140, 180, 150, 200 and 160). The first piece (140) is a 1 7/16″ socket. (180) is a 1 1/16″ socket to remove and replace propeller nuts. (150) is a 2⅜″×8″ long steel tube. (200) is a 15/16″ socket to remove and replace propeller nuts.

FIG. 7.2: a right side view of the present invention comprises of the first, second, third, fourth, fifth, sixth and seventh pieces (140, 170, 180, 150, 190, 200 and 160). A 1 7/16″ socket (140) as a first piece, is preferably welded securely to a particular sleeve. (170) is a 1⅞″ long sleeve welded to (150) to accommodate (180) a 1 1/16″ socket. (150) is a 2″×8″ steel tube. (190) is a 1⅞″ long steel sleeve welded to (150) to accommodate a 15/16″ socket (200). A 2¾″ hex socket (160) may be attached in order to remove and replace propeller nuts.

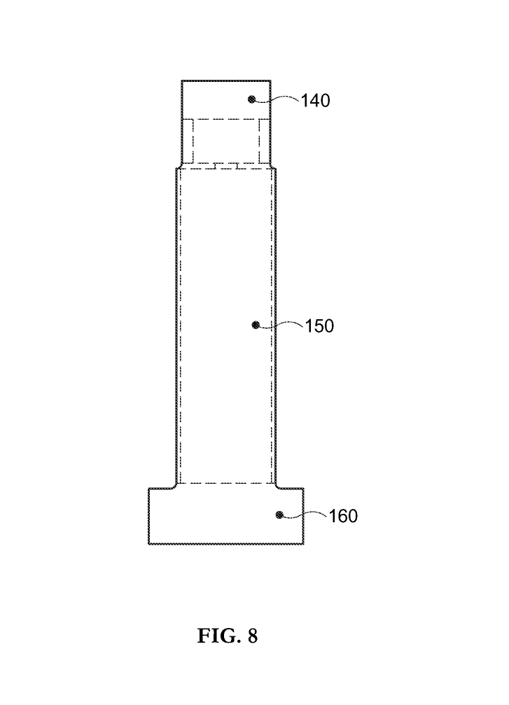

FIG. 8: a front view of the present invention, the Mercury I.O. (Inboard-Outboard) 2-in 1 (DIY) Do-It-Yourself Prop Wrench, comprises of a first piece (140), a second piece (150), and a third piece (160), respectively. In the preferred embodiment of the present invention, the first, second and third pieces (140, 150 and 160) are two (2) tools and one 2″×8″ long tube welded together. A 1 7/16″ socket (140) is welded to a 2″×8″ long steel tube (150). A 2¾″ hex socket (160) is welded to the bottom of the 2″×8″ long steel tube (150).

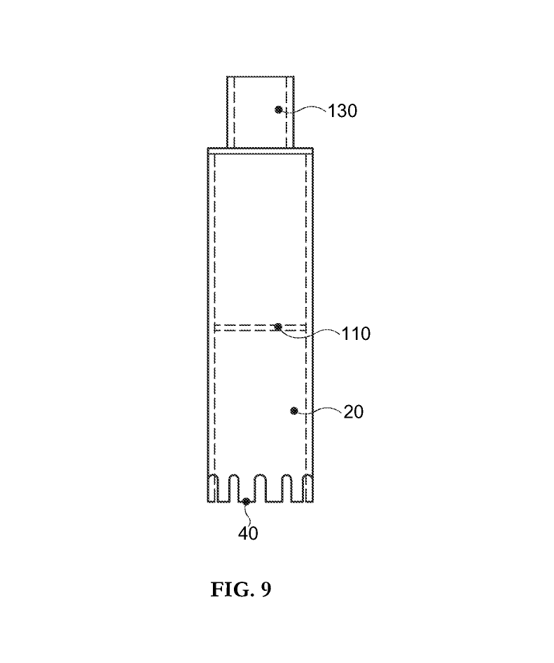

FIG. 9: a front view of the present invention, the Volvo Penta 2-in-1 (DIY) Do-It-Yourself Prop Wrench, comprises of four pieces (130, 110, 20 and 40), respectively. In the present embodiment of the present invention, the first, second, third and fourth pieces (130, 110, 20 and 40) are welded together. (130) is a 1 3/16″ socket welded to a 2″×8″ long steel tube (20). is a 2″ steel washer (110) is welded inside 2″×8″ long steel tube (20). (40) is nine (9) ½″×¼″ slots to remove and replace several different nuts.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The present invention should therefore not be limited by the above described embodiment, method, and examples, but by all embodiments and methods within the scope and spirit of the invention as claimed.

I claim:

1. A multi-tool wrench for propeller replacement comprising:
a 1 3/16″ socket;
wherein said 1 3/16″ socket has an open end and a closed end;
a 2″×8″ steel tube;
a 2″ steel washer;
wherein said 2″ steel washer is welded within said 2″×8″ steel tube;
wherein said 1 3/16″ is welded to said 2″×8″ steel tube;
at least one ½″×¼″ slot;
wherein said at least one ½″×¼″ slots is disposed along circumference of said open end; and
wherein said at least one ½″×¼″ slot is sized to provide for the removal and replacement of a number of different nuts.

2. The multi-tool wrench for propeller replacement of claim 1, wherein said 1 3/16″ socket is modular.

3. A multi-tool wrench for propeller replacement comprising:
a 1 3/16″ standard socket;
a 2″×8″ long steel tube;
steel sleeve;
wherein said 1 3/16″ standard socket is welded to said 2″×8″ long steel tube;
a 2″ washer;
wherein said 2″ washer is welded within said 2″×8″ long steel tube; and
further comprising a ¾″ hex socket affixed to said steel sleeve.
